(19) United States
(12) Patent Application Publication
(10) Pub. No.: US 2011/0084576 A1
(43) Pub. Date: Apr. 14, 2011

(54) Modular integrated outdoor locker and system

(76) Inventor: Todd R. Leatherman, Toms River, NJ (US)

(21) Appl. No.: 12/587,689

(22) Filed: Oct. 9, 2009

(51) Int. Cl. A47B 81/00; E05B 65/44

(52) U.S. Cl. 312/100; 70/78

(57) ABSTRACT

A modular integrated outdoor locker and system of interconnected locker units with common walls includes a floor base, four posts attached to the floor base, two side wall panels connected to the posts by panel assemblies and one back wall connected to the rear posts. A panel assembly includes an upper and lower track and two sets of opposing track connectors to connect the tracks to the posts. The lower track and each of the lower track connectors have at least one weep opening for water drainage. A front top brace connects the left and right front posts. A door is hingedly connected to either the left or right front post and has a lock mechanism for locking the door. A roof member with a back nape and downward taper from back to front provides side ventilation and is connected atop the posts.

### BACKGROUND OF INVENTION

a. Field of Invention

The present invention relates generally to individual locker units and serial locker units (systems) that are based on modular construction that provide for units with waterproof components and with infinitely expandable linking capabilities utilizing common wall panels between units. By “outdoor” is meant a locker that can withstand outdoor elements, and thus may be utilized indoors or outdoors. The present invention units also provide for upper and lower ventilation while preventing intrusion and provide for hidden weep holes to inhibit collection of rainwater, thus preventing stagnation, water damage, etc. The main support structure is preferably extruded aluminum with powder coatings.

b. Description of Related Art

The following patents are representative of the field pertaining to the present invention:

U.S. Pat. No. 6,499,817 B2 to Richard B. Jermain describes a locker comprised of a first side wall having an interlocking portion, a second side wall having a first interlocking portion engaging the interlocking portion of the first side wall and a second interlocking portion, and a third side wall having an interlocking portion engaging the second interlocking portion of the second side wall. A coin receptacle, coin receptacle locking mechanism, a shelf and a door for the locker are also disclosed. A method of manufacturing a locker is also provided. The method comprises cutting a first wall from a first material to a desired length, cutting a second wall from the first material to the desired length, cutting a third wall to the desired length, and slidingly engaging the first, second and third walls. A method for limiting access to a locking mechanism is also provided, which comprises positioning the locking mechanism adjacent an inward facing surface and fastening the locking mechanism to the locker.

U.S. Pat. No. 6,474,759 B2 to Mu-Chuan Hsu describes a detachable cabinet comprised of a bottom plate including four slots each on a corner, two spaced wells on the rear side, and a projection on the corner at the front side. A pair of side plates each includes two bottom pegs, a front longitudinal groove, an abutment member clung onto the front longitudinal groove, a rear longitudinal groove, and two spaced studs on the top. A rear plate includes two spaced studs on the bottom and on the top. A top plate includes six apertures on the bottom side and a slot on a front corner at the bottom side. A front door includes a projection on the top at the side opposite to a handle and a slot on the bottom on the same side as the projection of the door. A number of configurations are possible. Further, the cabinet is easy to assemble and is sturdy.

U.S. Pat. No. 5,975,660 to Thomas A. Tisbo et al. describes a cabinet which includes a pair of spaced apart opposingly oriented, molded side panels, a molded rear panel disposed between the side panels at first edges thereof and joined thereto, a molded top panel disposed at an uppermost edge of the side and rear panels, a molded base panel in spaced, opposing relation to the top panel, disposed at a bottommost edge of the side and rear panels and a pair of pivotal, molded front door panels disposed in opposing relation to the rear panel and between the side panels and pivotally joined thereto. The cabinet includes corner support posts positioned at least two corners that extend between the base panel and the top panel. The posts that traverse through and join the respective side panels with the door panels define front corners forming pintles defining axes for pivoting the door panels relative to the side panels. The cabinet includes clamping members for securing the posts to the top and base panels, through the cabinet corners. The cabinet includes shelves and bins that are height adjustable that slide along rails formed in the cabinet side panels.

U.S. Pat. No. 5,931,553 to Roni Cohen describes an injected plastic cabinet comprising a top, a bottom, a back wall, and left and right side walls being connected together, forming a box having a front opening, and at least one door element being hingedly connected to at least one of the left and right side walls for covering the front opening, wherein each of the back wall, left and right side walls and each of the door elements is at least 160 centimeters in height and is a product of a single plastic injection.

U.S. Pat. No. 5,921,646 to James Hwang describes a movable storage cabinet which includes a base plate, two lateral side plates fixed to the based plate by hooks provided at the bottom of the side plates, a rear backing plate which is held in a groove in the base plate, and a top plate fixed to the side and rear backing plate by engagement components extending through holes in the top plate to engage engaging stubs on the side plates and rear backing plate. A pivotable door closes the front of the movable storage cabinet. The engaging components include each includes an engaging stub in the shape of a hollow cylinder, the bottom of which is secured to the top plate, and a shank of which is inserted into the central hole of an engaging stub on one of the side or backing plates. A positioning rod is insertable through the central hole in the outer sleeve of the hollow cylinder to lock the engaging stub within the outer sleeve, thereby locking the top plate to the side or backing plates.

U.S. Pat. No. 5,564,806 to Alan P. Keisling et al. describes a locker which comprises plastic panels and connectors on the edges of the panels for a snap together assembly that can be knocked down for shipment. A swing open front door plastic panel is also provided which preferably has a plastic hinge and plastic latch mechanism.

U.S. Pat. No. 5,372,415 to Thomas A. Tisbo et al. describes a storage locker constructed of recyclable thermoplastic that utilizes insertion tabs and sockets molded into the sides, top, bottom, front and side panels for permanent interlocking without the need of conventional fasteners. The storage locker is assembled on site by inserting the tabs of the appropriate panel into the socket receptacles of an adjoining panel. Assembly of a basic locker requires snap attachment of the side walls to the top and bottom panel. A front frame, preassembly with a hinged door panel, is snap attached to the structure to complete the assembly wherein the structure is available for mounting directly to a wall. For a stand alone locker assembly, a perforated rear panel is available for attachment to the rear of the locker by use of locker pins. The rear panel provides aeration and allows various hook placement for hanging items. Shelves are available in either fixed or adjustable disposition. Sides, top, and bottom panels include provisions for attaching additional lockers in a stacked or gang configuration.

Notwithstanding the prior art, the present invention is neither taught nor rendered obvious thereby.

### SUMMARY OF INVENTION

The present invention is a modular integrated outdoor locker, as well as a system that creates a plurality of interconnected locker units with at least one common wall, and preferably with as many common walls as possible. The present invention modular integrated outdoor locker includes: a) a floor base, the floor base including a frame, flooring positioned atop the frame, and a plurality of post attachment mechanisms; b) four posts, each of the four posts being corner posts and being attached to the floor base, one each of the posts being a front left post, a front right post, a rear left post and a rear right post; c) two opposing side wall panels and one back wall, each of the side wall panels having a top, a bottom and sides; each of the side wall panels being connected to the posts to create locker sides and the one back wall being connected to the rear posts to create a locker back, each of the panels being connected to the posts by panel assemblies; d) two panel assemblies connected to the posts, one for each of the two opposing side wall, each of the panel assemblies including an upper track for encompassing and positioning a top of a panel, a lower track for encompassing a bottom of a panel, the lower track having at least one weep opening for water drainage therefrom, and each of the panel assemblies having two opposing upper track connectors and two opposing lower track connectors, for connecting the upper tracks and lower tracks, respectively, to the posts, each of the lower track connectors having at least one weep opening for water drainage therefrom; e) a front top brace connecting a top area of the left front post to a top area of the right front post; f) a door hingedly connected to one of the left front post and the right front post and having a lock mechanism for locking the door; g) a roof member atop the posts and connected to the posts, the roof member being downwardly tapered from back to front, the roof member having a back nape. Alternatively, the roof member may have a hemmed edge.

In some preferred embodiments of the present invention modular integrated outdoor locker, the side wall panels are plastic panels selected from the group including of thermoplastic, cellular polyvinyl chloride, cellular urethane and wood-plastic composite.

In some preferred embodiments of the present invention modular integrated outdoor locker, the one back wall is a fixed wall extending beyond the posts. In some other preferred embodiments of the present invention modular integrated outdoor locker, the once back wall is a back panel and a third panel assembly connecting the back panel to the rear posts.

In some preferred embodiments of the present invention modular integrated outdoor locker, the posts are extruded aluminum posts. In some of these preferred embodiments of the present invention modular integrated outdoor locker, the aluminum extruded posts are powder coated aluminum extruded posts.

In some preferred embodiments of the present invention modular integrated outdoor locker, the front top brace is an upper track and two upper track connectors.

In some preferred embodiments of the present invention modular integrated outdoor locker, the track connectors are inverted U-shaped connectors and the lower track connectors are U-shaped connectors. In some of these preferred embodiments of the present invention modular integrated outdoor locker, the inverted U-shaped connectors and the U-shaped connectors are identical and have at least one weep opening for water drainage therefrom. In some of these preferred embodiments of the present invention modular integrated outdoor locker, the inverted U-shaped connectors and the U-shaped connectors each have two components, a first component being a screw-attachable, tongue-receiving post bracket, and a second component being a first component-concealing, first component interconnecting tongue bearing three sided track support.

In some preferred embodiments of the present invention modular integrated outdoor locker, the posts have a rectangular footprint and have vertical recesses on four sides adapted to receive and position upper track connectors and lower track connectors.

In some preferred embodiments of the present invention modular integrated outdoor locker, the lock is selected from the group including of a handle set lock, a cam lock, a tee lock, a paddle lock and a thumb turning lock. In some embodiments, the lock mechanisms include coin operation features, such as a coin receptacle locking mechanism. Alternatively, keyed or combination locks may be used.

In some other preferred embodiments of the present invention, the modular integrated outdoor locker system includes at least two connected lockers sharing at least one common wall panel. The present invention system includes: a) a floor base, the floor base including a frame, flooring positioned atop the frame, and a plurality of post attachment mechanisms; b) at least six posts, four of the at least six posts being corner posts, one of each corner post being a front left post, a front right post, a rear left post and a rear right post, at least one of the at least six posts being a front center post and at least one of the at least six posts being a rear center post, c) two opposing side wall panels and at least one back wall, each of the two opposing side wall panels having a top, a bottom and sides; each of the two opposing side wall panels being connected to the corner posts to create locker sides and the at least one back wall being connected to the rear posts to create a locker system back, each of the two opposing side wall panels being connected to the posts by panel assemblies; d) a plurality of panel assemblies connected to the posts, one for each of the two opposing side wall panels, each of the panel assemblies including an upper track for encompassing and positioning a top of a panel, a lower track for encompassing a bottom of a panel, the lower track having at least one weep opening for water drainage therefrom, and each of the panel assemblies having two opposing upper track connectors and two opposing lower track connectors, for connecting the upper tracks and lower tracks, respectively, to the posts, each of the lower track connectors having at least one weep opening for water drainage therefrom; e) at least two front top braces connecting a top area of the left front post to a top area of a center post and connecting to a top area of the right front post; f) at least two doors hingedly connected to one of the left front post, the right front post and the center post and below a top brace, and having a lock mechanism for locking each of the at least two doors; g) a roof member atop the posts and connected to the posts, the roof member being downwardly tapered from back to front, the roof member having a back nape. Alternatively, the roof member may have a hemmed edge.

In some preferred embodiments of the present invention modular integrated outdoor locker system, the two opposing side wall panels are plastic panels selected from the group including of thermoplastic, cellular polyvinyl chloride, cellular urethane and wood-plastic composite.

In some preferred embodiments of the present invention modular integrated outdoor locker system, the at least one back wall is a fixed wall extending beyond the posts. In some other preferred embodiments of the present invention modular integrated outdoor locker system, the once back wall is a back panel and a third panel assembly connecting the back panel to the rear posts.

In some preferred embodiments of the present invention modular integrated outdoor locker system, the posts are extruded aluminum posts. In some of these preferred embodiments of the present invention modular integrated outdoor locker system, the aluminum extruded posts are powder coated aluminum extruded posts.

In some preferred embodiments of the present invention modular integrated outdoor locker system, the at least two front top braces are upper tracks with upper track connectors.

In some preferred embodiments of the present invention modular integrated outdoor locker system, the upper track connectors are inverted U-shaped connectors and the lower track connectors are U-shaped connectors. In some of these preferred embodiments of the present invention modular integrated outdoor locker, the inverted U-shaped connectors and the U-shaped connectors are identical and have at least one weep opening for water drainage therefrom. In some of these preferred embodiments of the present invention modular integrated outdoor locker, the inverted U-shaped connectors and the U-shaped connectors each have two components, a first component being a screw-attachable, tongue-receiving post bracket, and a second component being a first component-concealing, first component interconnecting tongue bearing three sided track support.

In some preferred embodiments of the present invention modular integrated outdoor locker system, the posts have a rectangular footprint and have vertical recesses on four sides adapted to receive and position upper track connectors and lower track connectors.

In some preferred embodiments of the present invention modular integrated outdoor locker system, the lock is selected from the group including of a handle set lock, a cam lock, a tee lock, a paddle lock and a thumb turning lock. In some embodiments, the lock mechanisms include coin operation features, such as a coin receptacle locking mechanism. Alternatively, keyed or combination locks may be used.

In some preferred embodiments of the present invention modular integrated outdoor locker system, the floor base has a rectangular footprint, and the posts are arranged in a rectangular configuration with side-by-side doors, creating side-by-side locker units.

In some preferred embodiments of the present invention modular integrated outdoor locker system, the floor base has a rectangular footprint and the posts are arranged in a rectangular configuration, creating back-to-back units.

In some preferred embodiments of the present invention modular integrated outdoor locker system, the floor base has a rectangular footprint with a central member running from side to side, and the posts are arranged in a two row rectangular configuration to create two rows of back-to-back units.

The additional features set forth above are also features integrated with the present invention modular integrated outdoor locker system that create a plurality of interconnected locker units with at least one common wall, and preferably with as many common walls as possible. These lockers may be full lockers, vertical lockers (narrower than full) or half lockers (over/under dual doors).

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is an oblique view of an embodiment of a modular integrated outdoor locker according to the present invention with an open door;

FIG. 2 is a top view of the floor base of FIG. 1 with flooring removed;

FIG. 3 is a side cut view of the floor base of FIG. 1;

FIG. 4 is a post with base mount for connection to the post mounts of the floor base;

FIG. 5 is an oblique view of a panel used in the present invention;

FIG. 6 is a front view of the first component of the U-shaped track connector.

FIG. 7 is a front view of the second component of the U-shaped track connector.

FIG. 8 is an exploded view of a panel, panel assembly and posts illustrating how the components are connected;

FIG. 9 is a front view of a modular integrated outdoor locker with the door removed;

FIG. 10 is a front view of a modular integrated outdoor locker with shelving, hooks and towel racks mounted inside the locker.

FIG. 11 is a front view of the modular integrated outdoor locker of FIG. 9 with the door attached;

FIG. 12 is an oblique view of the roof member of the modular integrated outdoor locker;

FIG. 13 is a top view of the foot print of a modular integrated outdoor locker system comprised of two lockers connected by a common frame member to form a row of lockers;

FIG. 14 is a top view of the foot print of a modular integrated outdoor locker system comprised of four lockers connected by four common frame members to form back to back rows of lockers;

FIG. 15 is a top view of the foot print of a modular integrated outdoor locker system comprised of four lockers connected by three common frame members to form an “L” shaped row of lockers;

FIG. 16 is a top view of the foot print of a modular integrated outdoor locker system comprised of seven lockers connected by six common frame members to form a “Z” shaped row of lockers;

FIG. 17 provides an oblique view of another embodiment of the present invention outdoor locker which uses an existing wall structure in place of a back panel;

FIG. 18 provides a top view of the footprint of a modular integrated outdoor locker system comprised of four lockers connected by two common wall panels and a common fixed back wall;

FIG. 19 provides a an oblique view of another embodiment of the present invention outdoor locker which has a roof featuring standing seems; and

FIG. 20 provides a top view of the footprint of a modular integrated outdoor locker system comprised of nine lockers in three rows with a common fixed back wall.

### DETAILED DESCRIPTION OF THE EMBODIMENTS

The present invention modular integrated outdoor locker has numerous features that offer improved functionality over prior art. The present invention is developed for outdoor use, such as outdoor swimming pools, athletic fields, marinas, yacht clubs, beach clubs and other generally physically active environments. As such, it is important to provide adequate ventilation to the outdoor locker to allow items such as wet towels or sweaty attire to properly dry while still providing a secure locker. At least one wall panel, if not all wall panels, in the present invention is located above the floor base at sufficient height to allow air to flow through, but not high enough to pose a security risk or present the opportunity for injury. For example, the gap between the floor base and the bottom of a panel should not be large enough for a child to be able to slip into and become trapped within the outdoor locker. Open air is provided above the side walls as a result of the roof configuration, as described below, allowing air to pass both above and below the side wall panels. The roof member of the present invention outdoor locker is also tapered as described below to prevent water from entering the outdoor locker from above.

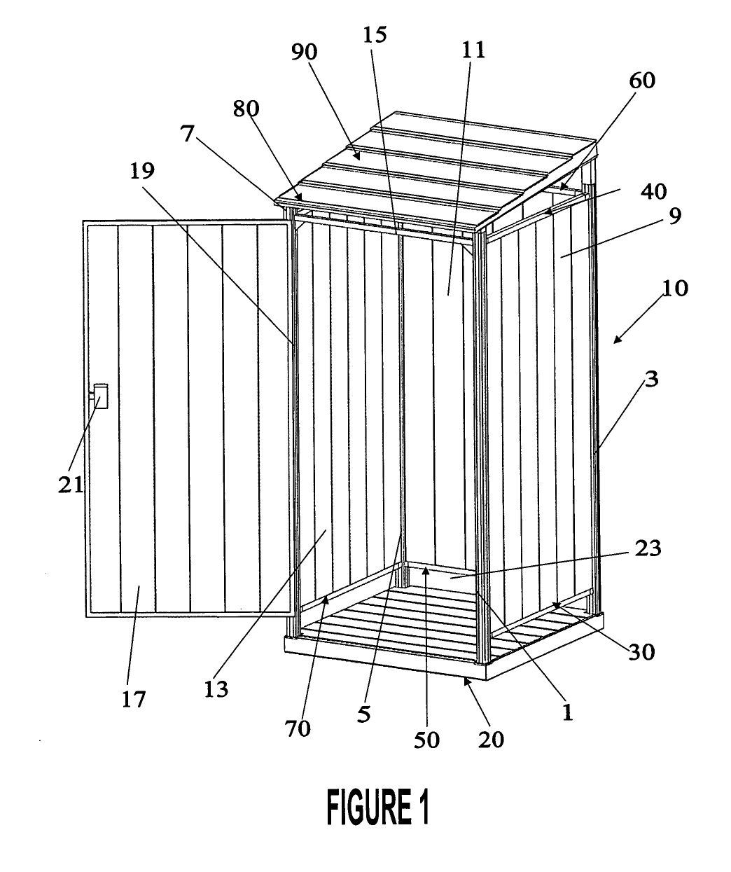

Referring now to the drawings wherein like reference numerals designate corresponding parts throughout the several views, FIG. 1 through FIG. 12.

FIG. 1 through FIG. 12 provide multiple views of a modular integrated outdoor locker and the components which comprise the outdoor locker itself. The outdoor locker is adapted to be quickly and easily built where it will be placed, while being strong enough to endure the effects of outdoor use or outdoor exposure, such as high wind and rain.

FIG. 1 presents an oblique view of an embodiment of outdoor locker 10 with door 17 open to provide an interior view. Outdoor locker 10 includes a floor base 20, front right post 1, rear right post 3, rear left post 5 and front left post 7, two opposing side wall panels 9 and 13, back panel 11, panel assemblies 30, 40, 50, 60, 70 and 80, front top brace 15, door 17 and roof member 90.

Opposing side wall panels 9 and 13 and back wall panel 11 are located above floor base 20 to allow create air gap 23 and allow air to flow under the panels. Door 17 is connected to the front left post 7 by hinge 19, although door 17 may be connected to front right post 1 depending on the application. Hinge 19 should be constructed out of a rust proof material such as stainless steel. The internal locking mechanism 21 is visible with door 17 open and should be constructed out of rust proof materials such as stainless steel. Roof member 90 has a forward and downward taper to allow moisture to nm off the roof member 90 without entering outdoor locker 10. Roof member 90 is developed without any sides extending to panel assemblies 40 or 80 to allow air to flow over the side wall panels 9 and 13. More detail for individual parts of outdoor locker 10 is provided below.

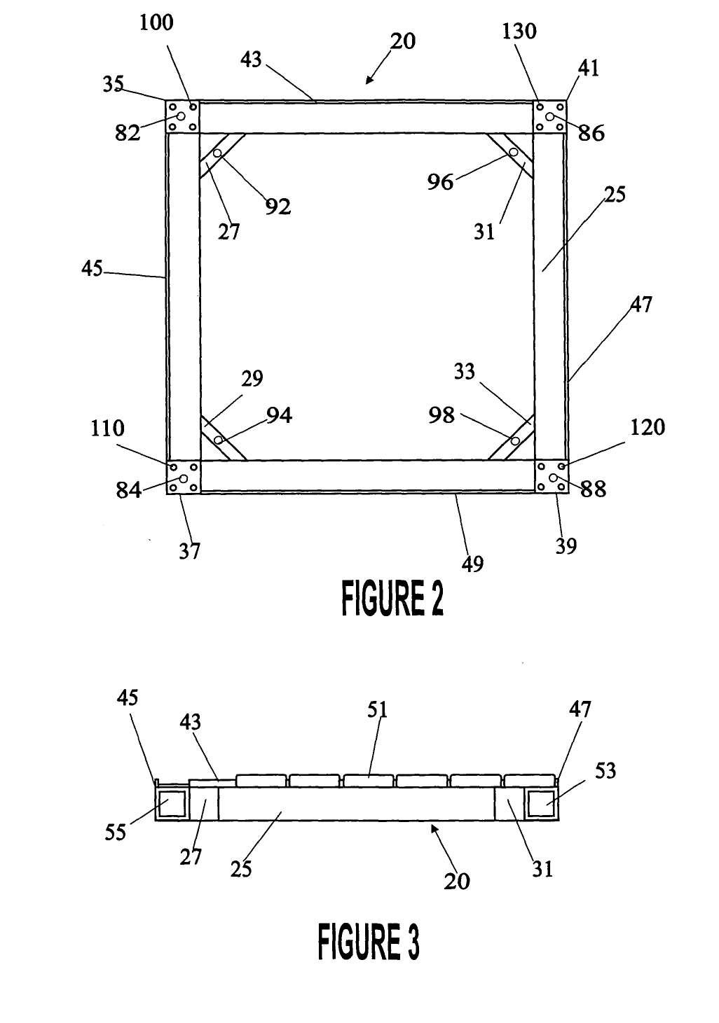

FIG. 2 provides a top view of floor base 20. The footprint of floor base 20 is defined by frame 25. In the current embodiment, frame 25 is a rectangle formed out of hollow box material, such as box steel, although other footprints and materials may be selected according to the application. Frame 25 is braced in the corners by support members 27, 29, 31 and 33 to improve the strength of the frame 25. Support members 27, 29, 31 and 33 each have holes 92, 94, 96 and 98 drilled centrally along them. Post attachment means 41, 35, 37 and 39 are located at the corners of frame 25 and include threaded bolt hole sets 130, 100, 110 and 120. Weep holes 82, 84, 86 and 88 are centrally located on post attachment means 41, 35, 37 and 39 to allow adequate water drainage. Individual post members, as described below, can be attached to the post attachment means 41, 35, 37 and 39 using threaded bolt hole sets 130, 100, 110 and 120 respectively. The post attachment means 41, 35, 37 and 39 and threaded bolt hole sets 130, 100, 110 and 120 are designed to reflect the base of the individual post members, which are further described below. Frame 25 has elevated lips 43, 44, 45 and 47 around the perimeter to aid in positioning flooring 51, as described below in FIG. 3, atop the frame 25.

FIG. 3 provides a side cut view of floor base 20 as described above in FIG. 2 with the addition of flooring 51 positioned atop frame 25. Cross sectional areas 55 and 53 clearly illustrate the use of hollow box steel in frame 25. FIG. 3 also serves to illustrate the height of lips 43, 45 and 47. Flooring 51 is shown partially atop frame 25 to illustrate the use of the lips 43 and 47 to position flooring 51. In use, flooring 51 would span between elevated lips 45 and 47 to completely cover frame 25.

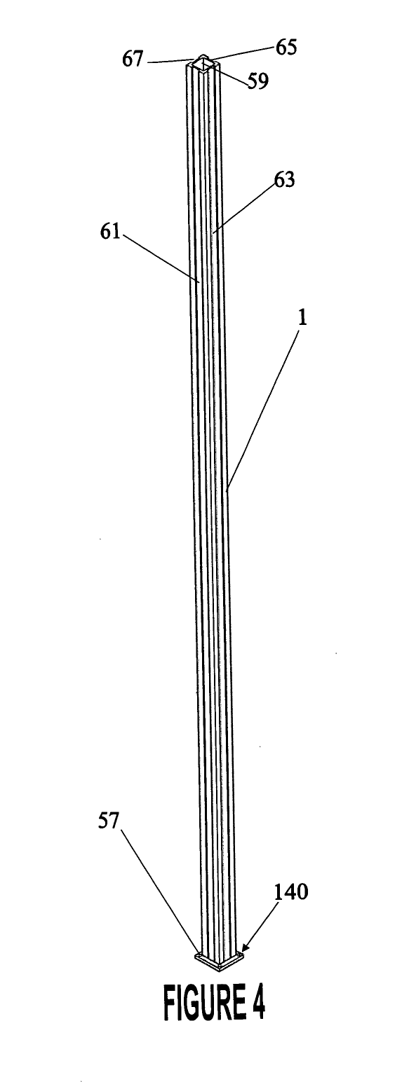

FIG. 4 provides an oblique view of front right post 1. Front right post 1 is an extruded aluminum post, which may be powder coated to provide a desired finish. The top opening 59 created during extrusion on front right post 1 can clearly be seen in FIG. 4. At the bottom of front right post 1 is the post base 57, adapted to attach to floor base 20. Threaded bolt hole set 140 will line up with the matching threaded bolt hole set 100, 110, 120 or 130 on the post attachment means 35, 37, 39 or 41 to allow front right post 1 to securely be attached to the floor base 20. Recessed tracks 61, 63, 65 and 67 run along the length of each side of front right post 1. These recessed tracks 61, 63, 65 and 67 are adapted to receive the first component of the U-shaped connectors described below. All posts 3, 5 and 7 used in the construction of the present invention modular integrated outdoor locker are identical to front right post 1.

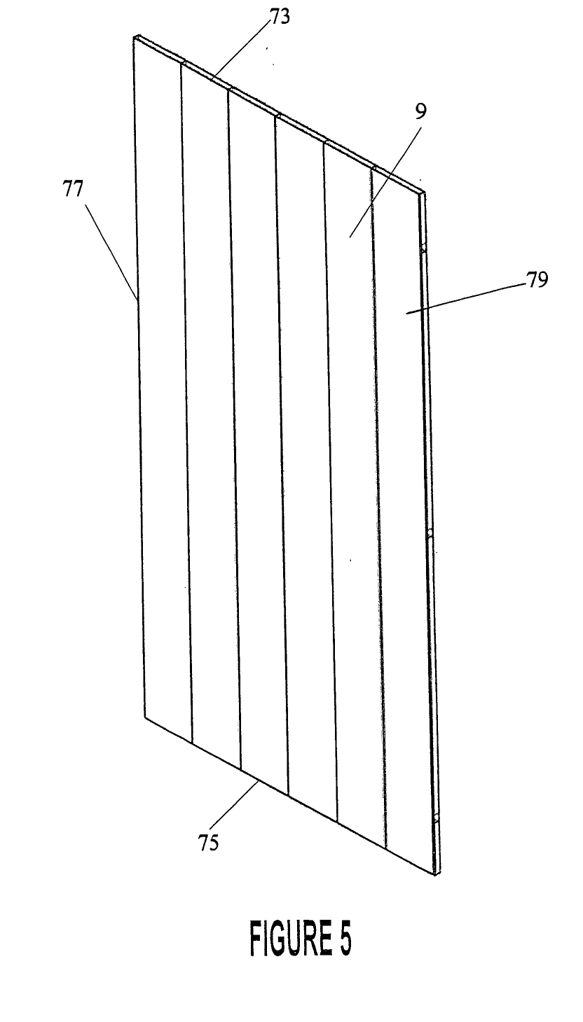

FIG. 5 provides an oblique view of opposing side wall panel 9. Opposing side wall panel 9 is constructed out of thermoplastic, cellular polyvinyl chloride, cellular urethane, or a wood-plastic composite to provide adequate strength and durability to the outdoor locker 10. Opposing side panel 9 is defined as having a top 73, bottom 75, and sides 77 and 79. Top 73 and bottom 79 are sized to nest into panel assemblies 30 and 40 as described below. The above description also applies to opposing side wall panel 13 and back panel 11.

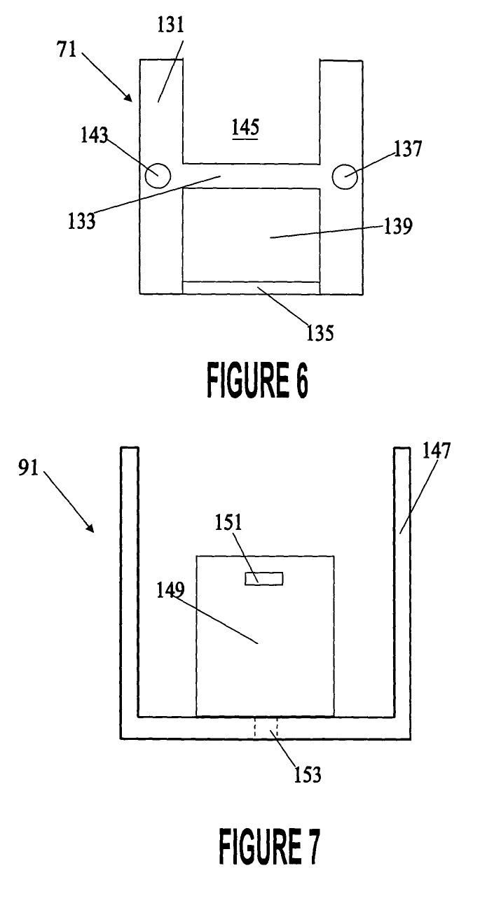

FIG. 6 provides a front view of the first component connector 71 of a U-shaped track connector. The first component connector 71 is a tongue-receiving post bracket formed from a flat back section 131 adapted to fit into the recessed tracks 61, 63, 65 and 67 of a post 1, 3, 5 and 7 and be attached using screw holes 137 and 143. A bottom enclosed opening 139 and top three sided opening 145 are located on the flat back section 131 with a lower cross bar 135 and central cross bar 133 adapted to support the first component connector 71.

FIG. 7 provides a front view of the second component U-shaped connector 91 of a U-shaped track connector. Second component U-shaped connector 91 consists of a U-shaped member 147 designed to receive and secure the track portion of a panel assembly as described below. A weep hole 153 is located on the bottom of U-shaped member 147 to allow moisture to drain from the present invention. A tongue 149 extends upwardly from the bottom of U-shaped member 147 and has a male locking mechanism 151 located towards the end of the tongue 149.

The second component U-shaped connector 91 is adapted to connect to the first component connector 71 by inserting tongue 149 into tongue-receiving protrusion 133. Male locking mechanism 151 forms a force fit between the first component connector 71 and second component U-shaped connector 91 when the two components 71 and 91 align as described below.

In use, the tongue 149 slides over lower cross bar 135 and under central cross bar 133. Male locking member 151 forms a force fit as it passes central cross bar 133. When the first component connector 71 and second component U-shaped connectors 91 are connected, second component U-shaped connector 91 conceals the first component connector 71. The first component connector 71 and second component U-shaped connector 91 can be used as illustrated to secure a lower track or inverted to secure an upper track as described below.

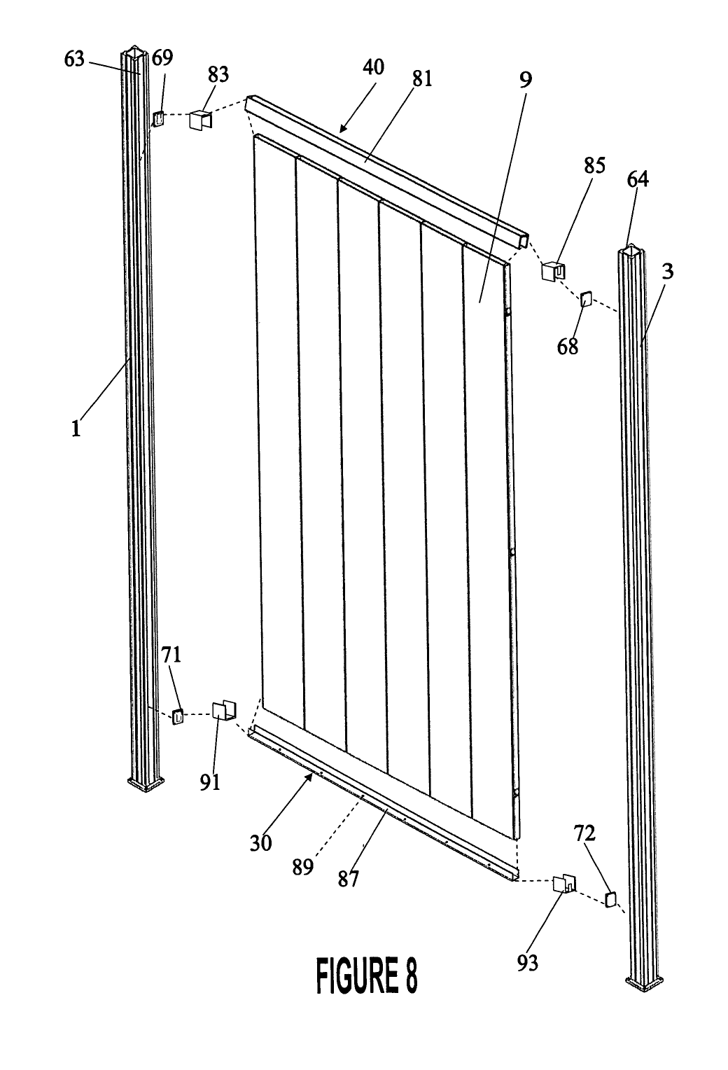

FIG. 8 provides an exploded view of an upper panel assembly 40, lower panel assembly 30, wide wall panel 9 and two posts 1 and 3, illustrating the connections between all members. Lower panel assembly 30 is formed by lower track 87, second component U-shaped connectors 91 and 93 and first component connectors 71 and 72. Lower track 87 has a plurality of weep holes 89 along it to aid in draining moisture from panel 9. The plurality of weep holes 89 are shown in dotted outline due to the fact that they are not normally visible from the perspective provided by FIG. 8. Similar to lower panel assembly 30, upper panel assembly 40 is formed by upper track 81, second component inverted U-shaped connectors 83 and 85 and first component connectors 68 and 69.

To assemble the above described components, first component connectors 68, 69, 71 and 72 are inserted into the recessed tracks 63 and 64 and secured at the desired height as described above. Second component U-shaped connectors 91 and 93 are then connected to first component connectors 71 and 72 respectively as described above. Lower track 87 can then be nested into second component U-shaped connectors 91 and 93 to form a lower panel assembly 30 connected to posts 1 and 3. Side wall panel 9 can then be inserted into the lower track 87 of lower panel assembly 30. Upper track 81 fits over the free end of panel 9 as shown and nests into second component inverted U-shaped connectors 83 and 85. Second component inverted U-shaped connectors 83 and 85 can then be attached to first component connectors 68 and 69 as described above to form upper panel assembly 40 and secure side wall panel 9 between posts 1 and 3. This same method can be applied to opposing side wall panel 13 and back panel 11.

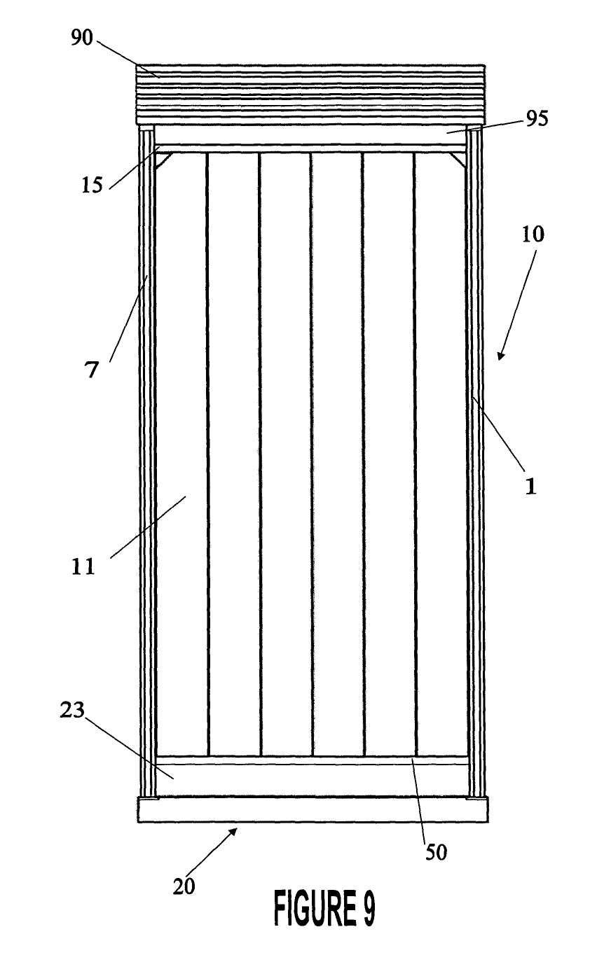

FIG. 9 through FIG. 11 provide multiple front views of a modular integrated outdoor locker. FIG. 9 shows outdoor locker 10 with door 17 removed to provide an unobstructed view of the back panel 11. Front right post 1 and front left post 7 are connected to floor base 20 as described above. Front top brace 15 is located between front right post 1 and front left post 3 to provide support to outdoor locker 10. Back panel 11 is attached to lower panel assembly 50 as described above, creating an air gap 23 for ventilation. Roof member 90 is atop front right post 1 and front left post 3 and connected thereto. The back nape 95 of the roof member 90 is partially visible from the front view. Back nape 95 extends downward from roof member 90 and lines up with back panel 11.

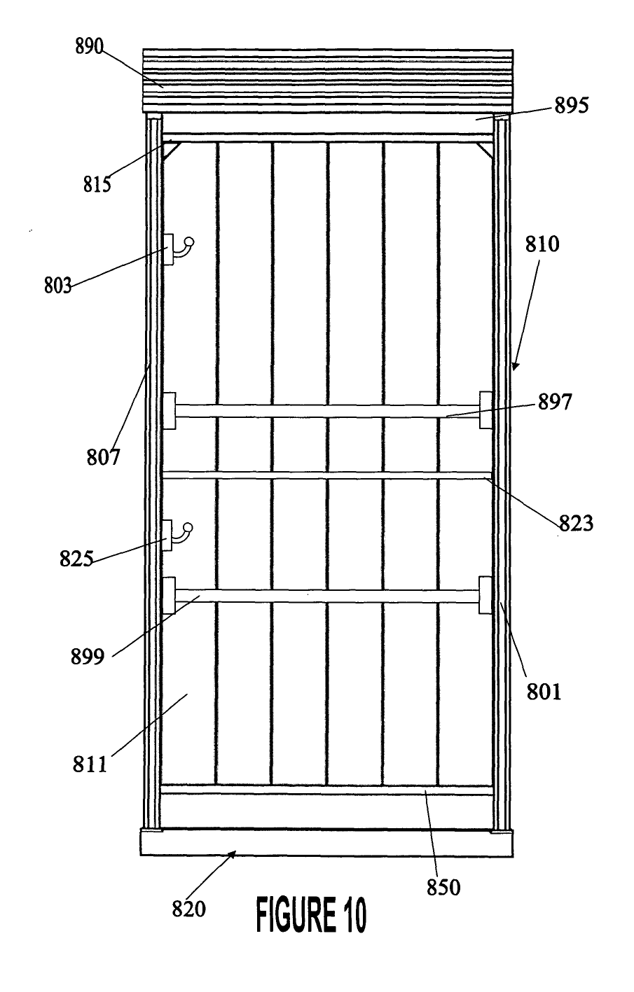

FIG. 10 adds a number of accessories to the interior of outdoor locker 810. Front right post 801 and front left post 807 are connected to floor base 820 as described above. Front top brace 815 is located between front right post 801 and front left post 803 to provide support to outdoor locker 810. Shelf 823 is shown as a horizontal flat rectangle running along back panel 811 between front right post 801 and front left post 807. Shelf 823 serves as additional storage space and affectively divides outdoor locker 810 into two interior sections. Hanger hooks 825 and 803 and towel racks 897 and 899 are mounted in paired sets inside outdoor locker 810 to increase the functionality thereof. Other accessories, such as benches or seats, may be placed inside outdoor locker 810 depending on the application. The back nape 895 of the roof member 890 is partially visible from the front view. Back nape 895 extends downward from roof member 890 and lines up with back panel 811.

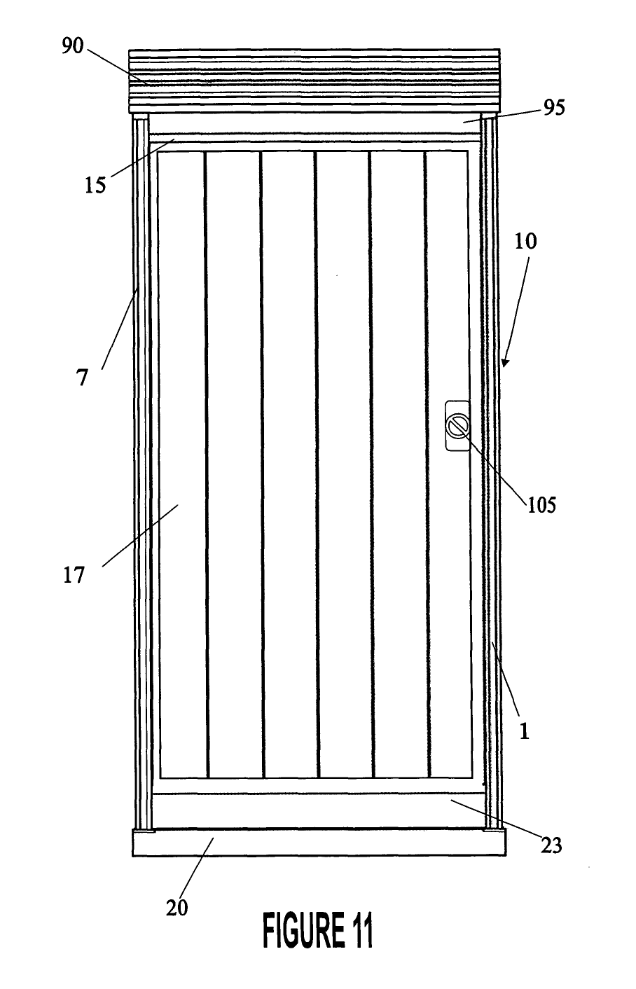

FIG. 11 depicts outdoor locker 10 with the door 17 hingedly connected to front left post 7 and secured shut by locking mechanism 105 which should be constructed out of rust proof materials such as stainless steel. Outdoor locker 10 is formed as described above for FIG. 9. Door 17 runs from the floor base 20 nearly to the front top brace 15, and is adapted to rotate about the connected post, in the current embodiment front left post 7, although door 17 can similarly be connected to front right post 1. Door 17 is located above floor base twenty to create an air gap 23 to permit ventilation of outdoor locker 10. Door 17 has a locking mechanism 105, which may be a handle lock set, a cam lock, a tee lock, a paddle lock, a thumb turning lock, or a flush locking latch and should be constructed out of rust proof materials such as stainless steel. As shown, locking mechanism 105 is a cam lock that locks when rotated.

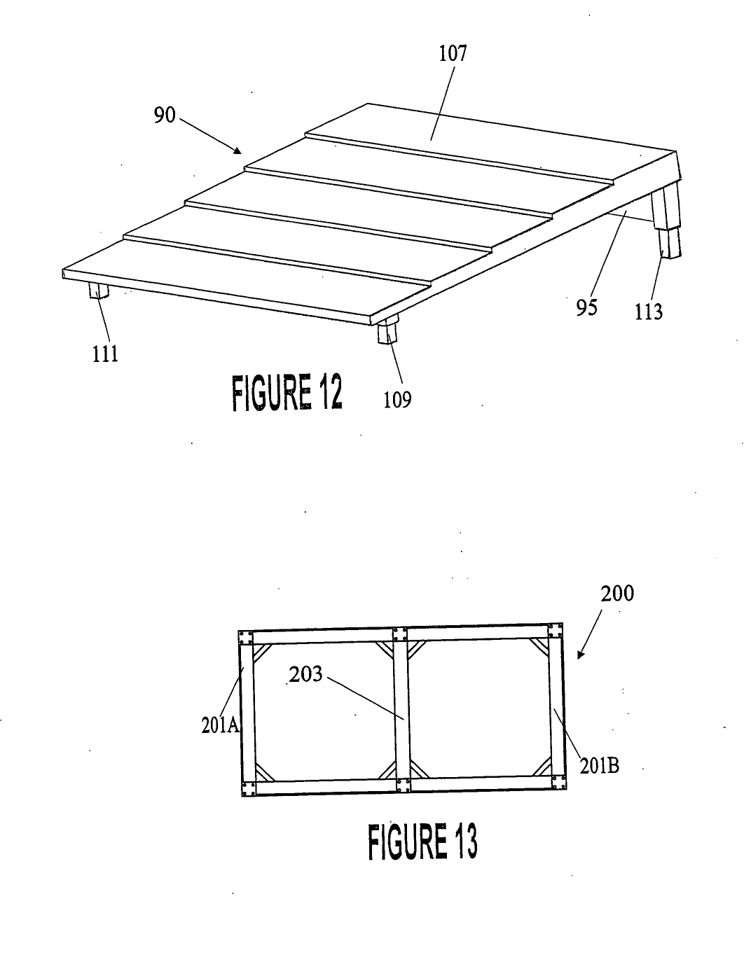

FIG. 12 provides an oblique view of roof member 90. The top of roof member 90 is formed by downwardly tapered roof 107. Downwardly tapered roof 107 is adapted to overhang the footprint of the outdoor locker 10 in order to prevent water from entering. In the current embodiment, downwardly tapered roof 107 is shown with a stepped profile, although other decorative patterns may be used, such as simulated shingles. Downwardly tapered roof 107 is connected to front post connectors 109 and 111 and rear post connectors 113, of which only one is visible in the current view. The post connectors 109, 111 and 113 are adapted to securely mount roof member 90 atop the corner post 1, 3, 5 and 7 of outdoor locker 10. Back nape 95 extends downwardly from the back of downwardly tapered roof 107 as described above. No member similar to back nape 95 is present on the sides of roof member 90 in order to allow air to flow through the outdoor locker 10.

The present invention also provides for a modular integrated outdoor locker system comprised of multiple outdoor lockers. FIG. 13 through FIG. 16 provide top views of various outdoor locker system configurations with the roof members, panels assemblies and flooring removed. The weep holes (not shown) in the post attachment means are the same as shown in FIG. 2.

FIG. 13 depicts a top view footprint of an outdoor locker system 200. Outdoor locker system 200 is formed by two side to side locker frames 201A and 201B, which are formed as described above with one notable exception. Locker frames 201A and 201B are connected in a single row and share a common frame member 203. This common frame member 203 allows the resulting locker system 200 to use a single wall panel as a shared central wall. While outdoor locker system 200 is shown with two locker frames 201A and 201B, the principle can be extended indefinitely to create a single row locker system of any length.

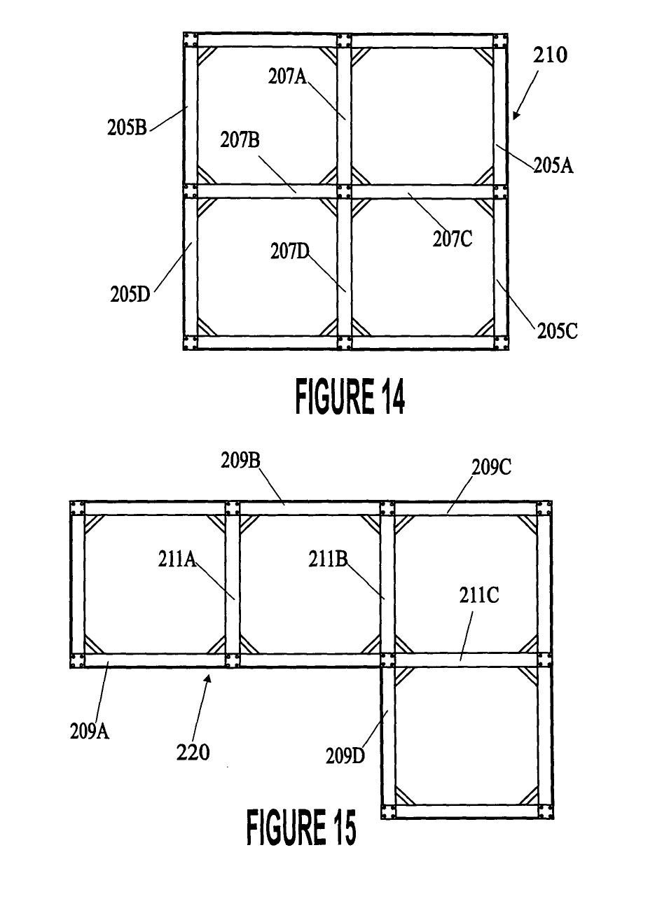

FIG. 14 depicts a top view footprint of an outdoor locker system 210. Outdoor locker system 210 is formed by four locker frames 205A, 205B, 205C and 205D which are formed as described above with one exception. Locker frames 205A, 205B, 205C and 205D are connected in two rows with shared central frame members 207A, 207B, 207C and 207D. A first row is formed by locker frames 205A and 205B with common frame member 207A as described above in FIG. 13. A second row is similarly formed by locker frames 205C and 205D with common frame member 207D. Locker frame 205B and 205D share a common frame member 207B and locker frame 205A and 205C share a common frame member 107C. The above described outdoor locker system 210 can be extended to create a two rowed outdoor locker system of any length.

FIG. 15 depicts a top view footprint of an outdoor locker system 220. Outdoor locker system 220 is formed by four locker frames 209A, 209B, 209C and 209D which are formed as described above. Locker frames 209A, 209B, 209C and 209D are connected in a single “L” shaped row with shared central frame members 211A, 211B and 211C. Such a formation could be useful for wrapping an outdoor locker system 220 around a corner.

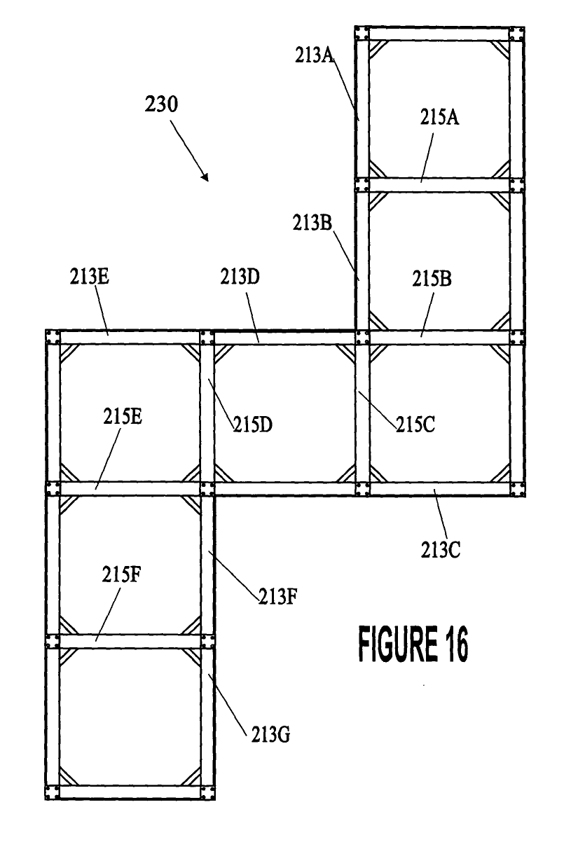

FIG. 16 depicts a top view footprint of an outdoor locker system 230. Outdoor locker system 230 is formed by seven locker frames 213A, 213B, 213C, 213D, 213E, 213F and 213G which are formed as described. Locker frames 213A, 213B, 213C, 213D, 213E, 213F and 213G are connected in a single row with two bends, forming a “Z” shaped row with shared central frame members 215A, 215B, 215C, 215D, 215E and 215F. Shared central frame members 215A, 215B, 215C, 215D, 215E and 215F allow for a reduction in the number of required frame members and wall panels used in constructing outdoor locker system 230.

In addition to the outdoor locker system footprints described above, additional configurations can be achieved using the same principles to fit individual application needs.

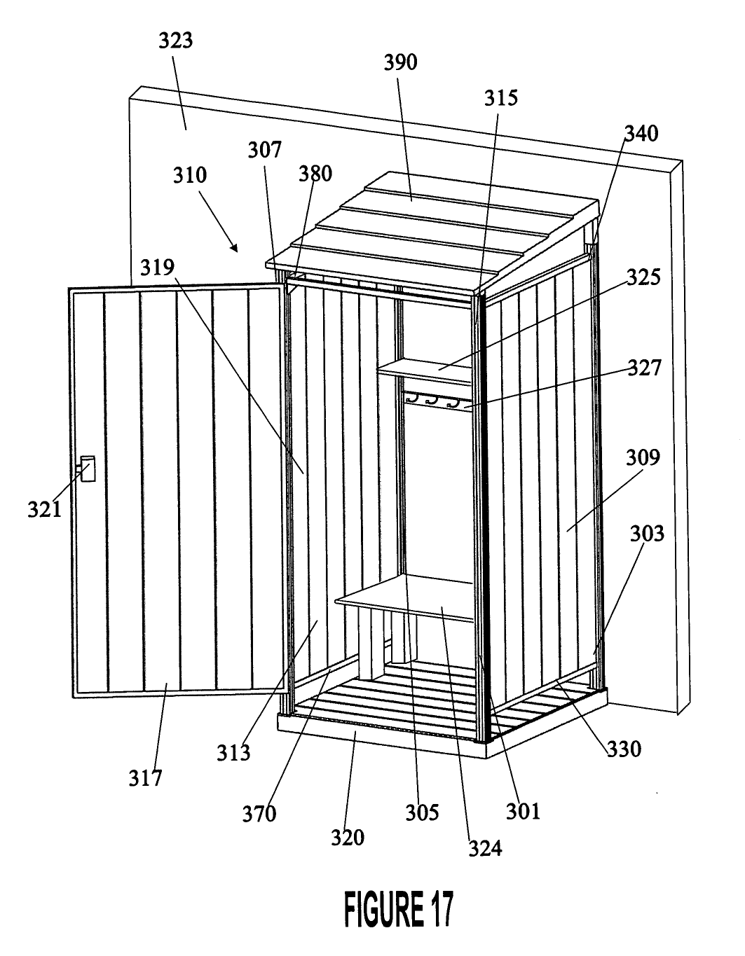

FIG. 17 provides an oblique view of another embodiment of the present invention outdoor locker 310 using a fixed wall 323. The outdoor locker 310 is comprised of floor base 320, front right post 301, rear right post 303, rear left post 305 and front left post 307, two opposing side wall panels 309 and 313, panel assemblies 330, 340, 370 and 380, front top brace 315, door 317 and roof member 390. Door 317 is connected to the front left post 307 by hinge 319. The door 317 may be connected to front right post 301 depending on the application. The internal locking mechanism 321 is visible on door 317 with door 317 open as shown. Outdoor locker 310 also includes a bench 324 to improve the functionality. A half shelf 325 is located between opposing side wall panels 309 and 313 to provide additional storage space, and welded hooks 327 are attached to fixed wall 323 below half shelf 325 to allow users to hang items.

Unlike previous embodiments described in FIG. 1 through FIG. 12, no back panel is used in the present outdoor locker 310. In the present embodiment, outdoor locker 310 is placed along a fixed wall 323, which connects to rear left post 305 and rear right post 303 to form the back wall of outdoor locker 310. This reduces the build materials required by the outdoor locker 310 and allows for the surface of the fixed wall 323 to be seen from inside outdoor locker 310.

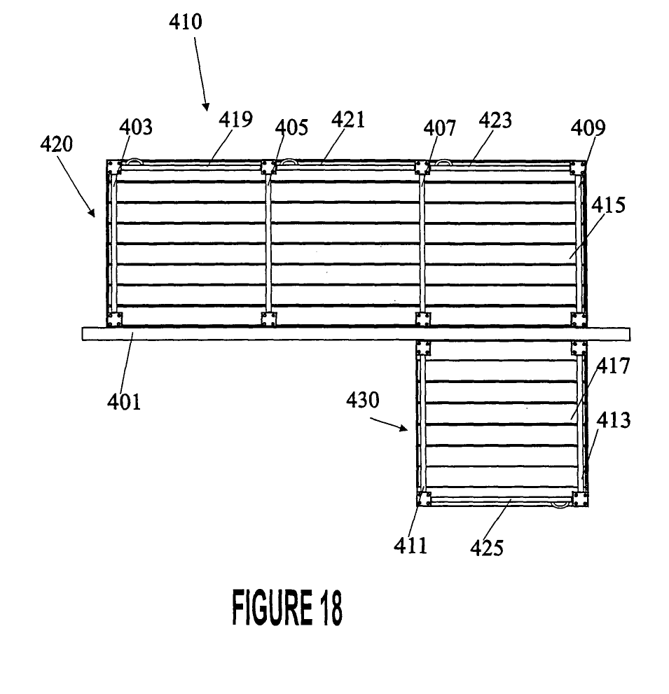

FIG. 18 provides a top view of a modular integrated outdoor locker system 410 comprised of a first row of outdoor lockers 420 and a second row of outdoor lockers 430 which share a common fixed back wall 401. The roof member has been removed from the outdoor locker system 410 in order to provide an improved view of the locker system's 410 shared components. The first row of outdoor lockers 420 is defined by opposing side wall panels 403 and 409, shared wall panels 405 and 407, doors 419, 421 and 423 and fixed back wall 401. Similarly, the second row of outdoor lockers 430 is defined by opposing side walls 411 and 413 and door 425. Opposing wall panels 403, 405, 407, 409, 411 and 413 and doors 419, 421, 423 and 425 are located atop flooring 415 and 417 with sufficient spacing to allow air to flow through the outdoor locker system 410. Wall panels 405 and 407 are common panels shared in the first row of outdoor lockers 420. Fixed back wall 401 is shared by the first row of outdoor lockers 420 and second row of outdoor lockers 430. It should be understood that the present invention is not limited to the number of individual outdoor lockers described in FIG. 18, but that the principles can be applied to create individual rows of outdoor lockers of any desired length.

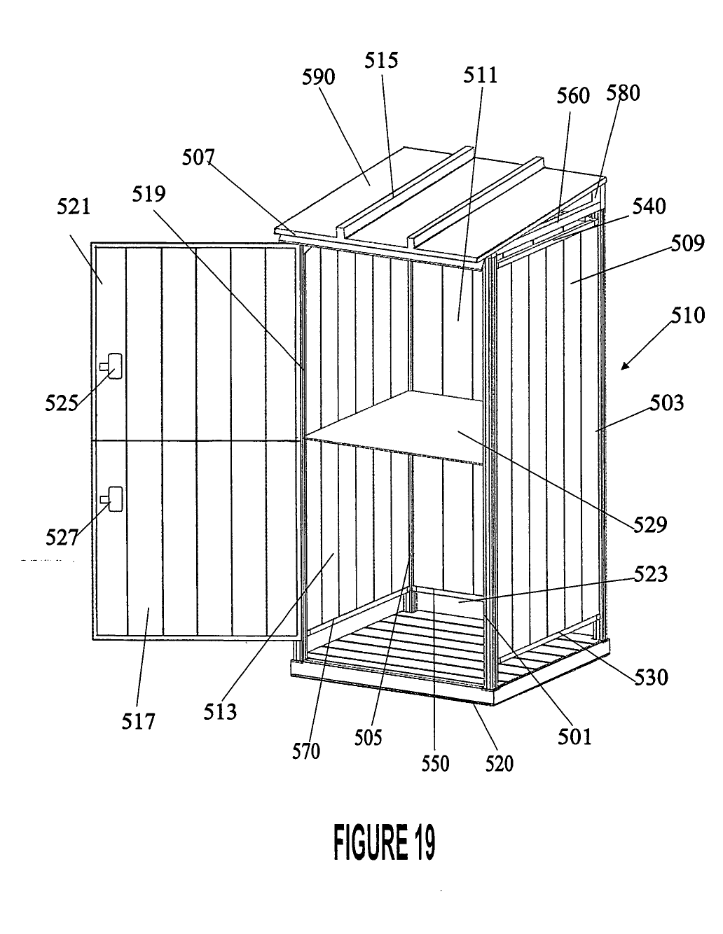

FIG. 19 presents an oblique view of an alternate embodiment of outdoor locker 510 with two doors 517 and 521 open to provide an interior view. Outdoor locker 510 includes a floor base 520, front right post 501, rear right post 503, rear left post 505 and front left post 507, two opposing side wall panels 509 and 513, back panel 511, panel assemblies 530, 540, 550 and 570, front top brace 515 and roof member 590.

Opposing side wall panels 509 and 513 and back wall panel 511 are located above floor base 520 to create an air gap 523. Door2 517 and 517 are connected to the front left post 507 by stainless steel hinge 519, although door 517 may be connected to front right post 501 depending on the application. Doors 517 and 521 are capable of opening independently of each other can both be locked by locking mechanisms 525 and 527. By allowing doors 517 and 521 to operate independently of each other, it allows access to both sections of locker 510, as divided by shelving 529. The internal locking mechanism 521 is visible with doors 517 and 521 open. Roof member 590 has a forward and downward taper provided by rear post 580 to allow moisture to run off the roof member 590 without entering outdoor locker 510. Roof member 590 has standing seams 515 and side support member 560, unlike previously described roof embodiments. Roof member 590 does not have any sides extending downward to allow air to flow over the side wall panels 509 and 513.

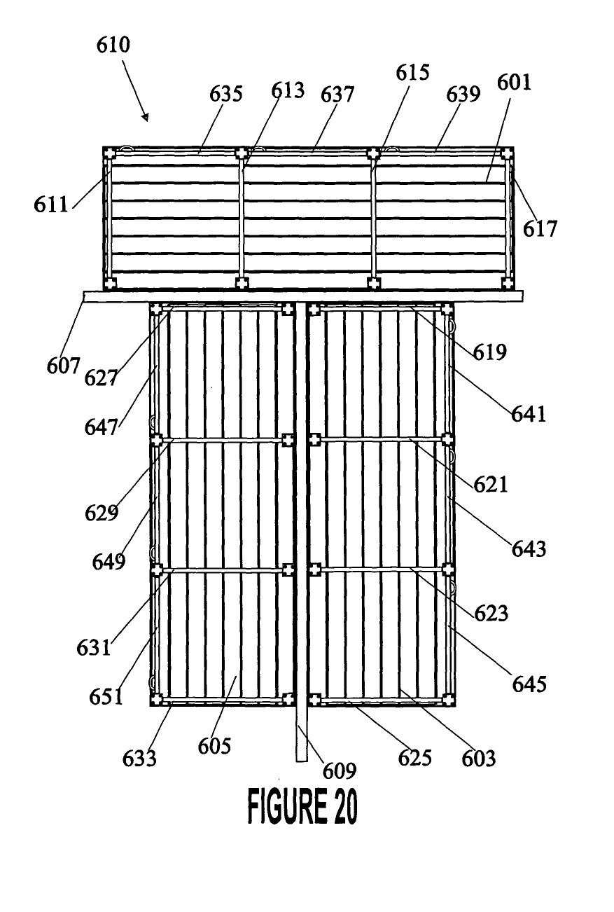

FIG. 20 provides a top view of the footprint of a modular integrated outdoor locker system 610 comprised of three rows of lockers 601, 603 and 605 with common fixed back wall 607 and 609. First row of outdoor lockers 601 is defined by side wall panels 611, 613, 615 and 617, doors 635, 637 and 639 and fixed back wall 607. Side walls 613 and 615 are shared common walls as described above. Second row of outdoor lockers 603 is formed in the same manner as described above, with side wall panels 619 and 625, shared side walls 621 and 623, doors 641, 643 and 645 and fixed back wall 609. Third row of outdoor lockers 605 is formed in the same manner as described above, with side wall panels 627 and 633, shared side walls 629 and 631, doors 647, 649 and 651 and fixed back wall 609, which is shared with second row of outdoor lockers 603. This configuration allows for a single outdoor locker system 610 to share multiple fixed walls 607 and 609 and wall panels 613, 615, 621, 623, 629 and 631.

To summarize, the present invention thus provides a modular integrated outdoor locker and a system consisting of at least two outdoor lockers. The modular integrated outdoor locker of the present invention consists of a floor base, posts, panels, a panel assembly for each panel, a back wall, a front top brace, a door hingedly connected to one of the posts, a lock mechanism on the door and a roof member atop the posts. The outdoor locker is adapted to provide air to flow over and under the panels.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. While developed for outdoor use or outdoor exposure, it should be understood that the present invention can be used in any environment, such as a school, sports club or any other environment where lockers are employed.

What is claimed is:

1. A modular integrated outdoor locker, which comprises:
a) a floor base, said floor base including a frame, flooring positioned atop said frame, and a plurality of post attachment means;
b) four posts, each of said four posts being corner posts and being attached to said floor base, one each of said posts being a front left post, a front right post, a rear left post and a rear right post;
c) two opposing side wall panels and one back wall, each of said side wall panels having a top, a bottom and sides; each of said side wall panels being connected to said posts to create locker sides and said one back wall being connected to said rear posts to create a locker back, each of said side wall panels being connected to said posts by panel assemblies;
d) two panel assemblies connected to said posts, one for each of said two opposing side wall panels and said back panel, each of said panel assemblies including an upper track for encompassing and positioning a top of a panel, a lower track for encompassing a bottom of a panel, said lower track having at least one weep opening for water drainage therefrom, and each of said panel assemblies having two opposing upper track connectors and two opposing lower track connectors, for connecting said upper tracks and lower tracks, respectively, to said posts, each of said lower track connectors having at least one weep opening for water drainage therefrom;
e) a front top brace connecting a top area of said left front post to a top area of said right front post;
f) a door hingedly connected to one of said left front post and said right front post and having a lock mechanism for locking said door;
g) a roof member atop said posts and connected to said posts, said roof member being downwardly tapered from back to front, said roof member having a back nape.

2. The modular integrated outdoor locker of claim 1 wherein said side wall panels are plastic panels selected from the group consisting of thermoplastic, cellular polyvinyl chloride, cellular urethane and wood-plastic composite.

3. The modular integrated outdoor locker of claim 1 wherein said one back wall is a fixed wall extending beyond said posts.

4. The modular integrated outdoor locker of claim 1 wherein said one back wall is a back panel and a third panel assembly connecting back panel to said rear posts.

5. The modular integrated outdoor locker of claim 1 wherein said posts are extruded aluminum posts.

6. The modular integrated outdoor locker of claim 5 wherein said aluminum extruded posts are powder coated aluminum extruded posts.

7. The modular integrated outdoor locker of claim 1 wherein said front top brace is an upper track and two upper track connectors.

8. The modular integrated outdoor locker of claim 1 wherein said upper track connectors are inverted U-shaped connectors and said lower track connectors are U-shaped connectors.

9. The modular integrated outdoor locker of claim 8 wherein said inverted U-shaped connectors and said U-shaped connectors are identical and have at least one weep opening for water drainage therefrom.

10. The modular integrated outdoor locker of claim 8 wherein said inverted U-shaped connectors and said U-shaped connectors each have two components, a first component being a screw-attachable, tongue-receiving post bracket, and a second component being a first component-concealing, first component interconnecting tongue bearing three sided track support.

11. The modular integrated outdoor locker of claim 1 wherein said posts have a rectangular footprint and have vertical recesses on four sides adapted to receive and position upper track connectors and lower track connectors.

12. The modular integrated outdoor locker of claim 1 wherein said lock is selected from the group consisting of a handle set lock, a cam lock, a tee lock, a paddle lock and a thumb turning lock.

13. A modular integrated outdoor locker system having at least two lockers, which comprises:
a) a floor base, said floor base including a frame, flooring positioned atop said frame, and a plurality of post attachment means;
b) at least six posts, four of said at least six posts being corner posts, one of each corner post being a front left post, a front right post, a rear left post and a rear right post, at least one of said at least six posts being a front center post and at least one of said at least six posts being a rear center post,
c) two opposing side wall panels one back wall, each of said two side wall panels having a top, a bottom and sides; each of said two opposing side wall panels being connected to said corner posts to create locker sides and said back wall being connected to said rear posts to create a locker system back, each of said panels being connected to said posts by panel assemblies;
d) a plurality of panel assemblies connected to said posts, one for each of said two opposing side wall panels, each of said panel assemblies including an upper track for encompassing and positioning a top of a panel, a lower track for encompassing a bottom of a panel, said lower track having at least one weep opening for water drainage therefrom, and each of said panel assemblies having two opposing upper track connectors and two opposing lower track connectors, for connecting said upper tracks and lower tracks, respectively, to said posts, each of said lower track connectors having at least one weep opening for water drainage therefrom;
e) at least two front top braces connecting a top area of said left front post to a top area of a center post and connecting to a top area of said right front post;
f) at least two doors hingedly connected to one of said left front post, said right front post and said center post and below a front top brace, and having a lock mechanism for locking each of said at least two doors;
g) a roof member atop said posts and connected to said posts, said roof member being downwardly tapered from back to front, said roof member having a back nape.

14. The modular integrated outdoor locker system of claim 13 wherein said side wall panels are plastic panels selected from the group consisting of thermoplastic, cellular polyvinyl chloride, cellular urethane and wood-plastic composite.

15. The modular integrated outdoor locker system of claim 13 wherein said one back wall is a fixed wall extending beyond said posts.

16. The modular integrated outdoor locker system of claim 13 wherein said one back wall is at least two back panels and at least two panel assemblies connecting said at least two back panels to said rear posts.

17. The modular integrated outdoor locker system of claim 13 wherein said posts are extruded aluminum posts.

18. The modular integrated outdoor locker system of claim 17 wherein said aluminum extruded posts are powder coated aluminum extruded posts.

19. The modular integrated outdoor locker system of claim 13 wherein said at least two front top braces are upper tracks with upper track connectors.

20. The modular integrated outdoor locker system of claim 13 wherein said upper track connectors are inverted U-shaped connectors and said lower track connectors are U-shaped connectors.

21. The modular integrated outdoor locker system of claim 20 wherein said inverted U-shaped connectors and said U-shaped connectors are identical and have at least one weep opening for water drainage therefrom.

22. The modular integrated outdoor locker system of claim 20 wherein said inverted U-shaped connectors and said U-shaped connectors each have two components, a first component being a screw-attachable, tongue-receiving post bracket, and a second component being a first component-concealing, first component interconnecting tongue bearing three sided track support.

23. The modular integrated outdoor locker system of claim 13 wherein said posts have a rectangular footprint and have vertical recesses on four sides adapted to receive and position upper track connectors and lower track connectors.

24. The modular integrated outdoor locker system of claim 13 wherein said lock is selected from the group consisting of a handle set lock, a cam lock, a tee lock, a paddle lock and a thumb turning lock

25. The modular integrated outdoor locker system of claim 13 wherein said floor base has a rectangular footprint, and said posts are arranged in a rectangular configuration with side-by-side doors, creating side-by-side locker units.

26. The modular integrated outdoor locker system of claim 13 wherein said floor base has a rectangular footprint and said posts are arranged in a rectangular configuration, creating back-to-back units.

27. The modular integrated outdoor locker system of claim 13 wherein said floor base has a rectangular footprint with a central member running from side to side, and said posts are arranged in a two row rectangular configuration to create two rows of back-to-back units.
